(19) United States
(12) Patent Application Publication
(10) Pub. No.: US 2010/0324951 A1
(43) Pub. Date: Dec. 23, 2010

(54) System and Method for Automated Compliance with Loan Servicing Legislation

(76) Inventor: Michael Patrick Northover, Lake Oswego, OR (US)

Correspondence Address: Michael Nothover, 4242 Southshore Blvd, Lake Oswego, OR, 97035, US

(21) Appl. No.: 12/490,298

(22) Filed: Jun. 23, 2009

(51) Int. Cl. G06Q 10/00; G06Q 50/00

(52) U.S. Cl. 705/7

(57) ABSTRACT

A computer-based system, technology architecture design, business process model, method, computer readable medium comprising software, and associated set of business services, for automatically determining business resolutions to municipal, state, and federal compliance rules, guidelines and legislation relating specifically to Mortgage and Credit Servicing (“Servicing”). Generic resolutions and normalized legislative information will be provided in human readable form via the internet by proprietary web search and querying applications. Specific resolutions for a loan or loan portfolio will be provided in computer readable via system interfaces. Resolutions are determined by means of rule-based processing technologies. Business Rules evaluate factors such as the location of a property or person, the life-cycle phase, status and disposition of the loan (e.g. 30 days delinquent, in foreclosure, subject to a modification program, etc.), and such additional criteria as may be required to determine accurate resolution in compliance with legislation. Preliminary industry research has indicated that these services and technologies do not currently exist in support of the Servicing industry.

### SUMMARY OF THE INVENTION

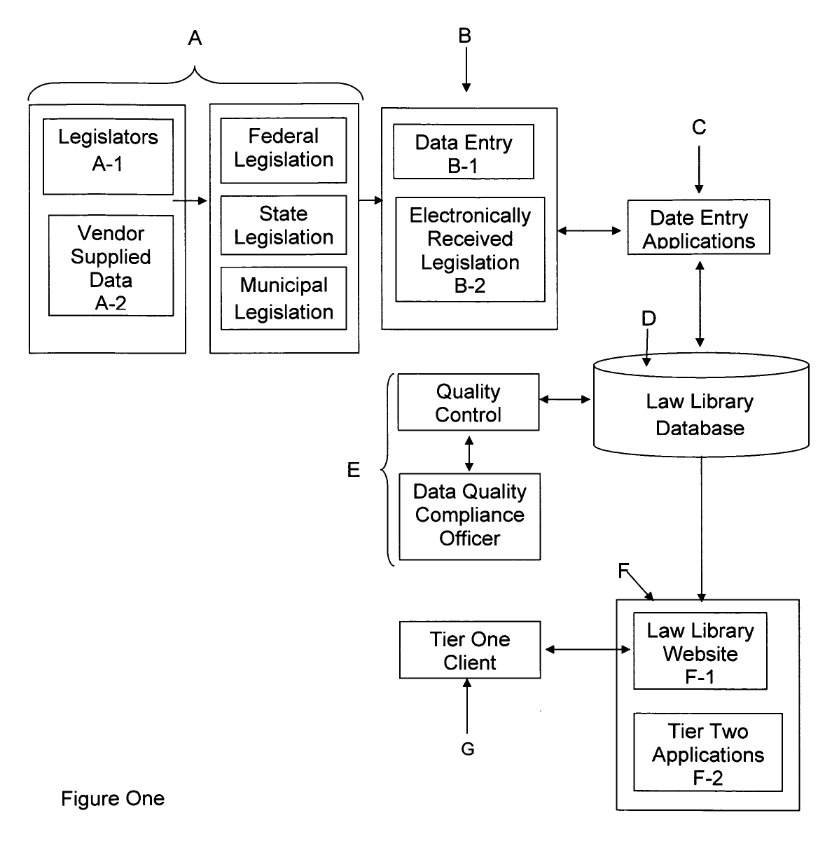

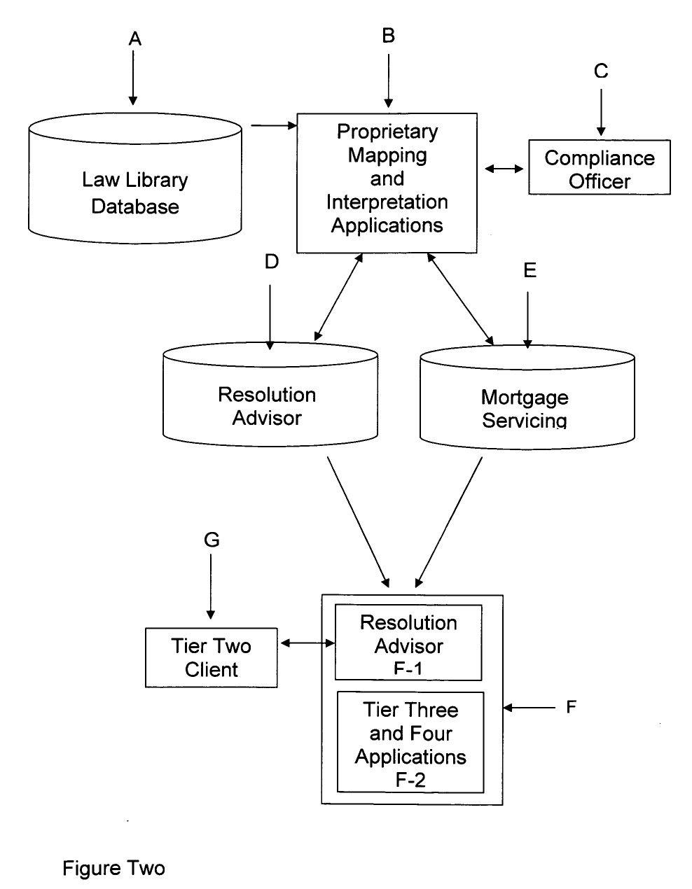

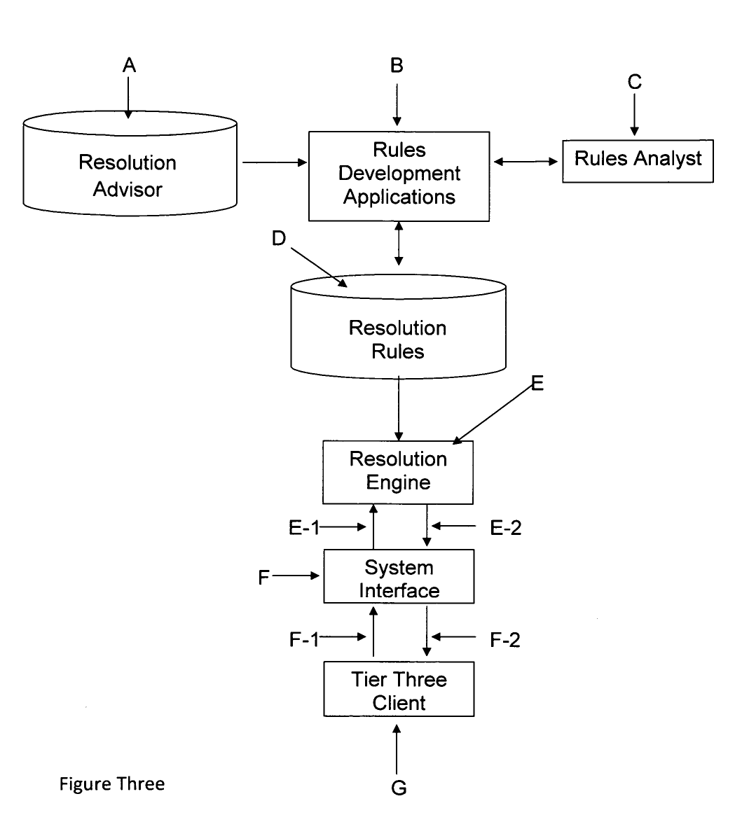

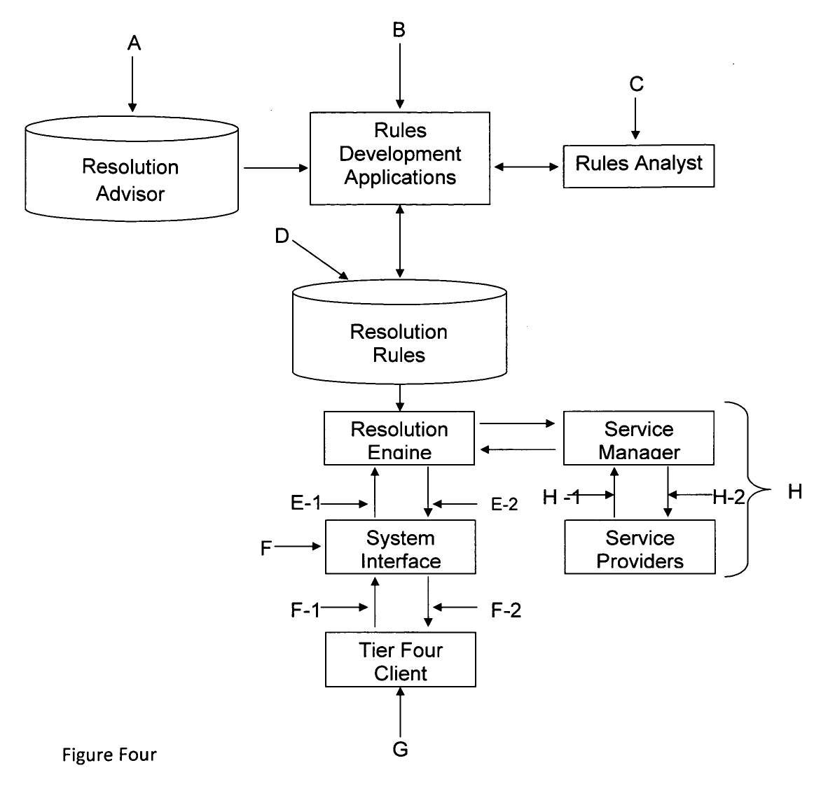

1. A computer-based system, technology architecture design, business process model, method, computer readable medium comprising software, and associated set of business services, for automatically determining business resolutions to municipal, state, and federal compliance rules, guidelines and legislation relating specifically to Mortgage and Credit Servicing (“Servicing”).
2. The system includes a storage subsystem for the collection, normalization, storage and access to all legislation applicable to the Servicing industry (“The Law Library”—FIG. 1).
3. The system includes a storage subsystem for the collection, normalization, storage and access to data representing the proprietary interpretation and resolution of legislation applicable to the Servicing industry, along with customized applications for performing the analysis and interpretation to produce such data (“The Resolution Advisor”—FIG. 2).
4. The system includes a storage subsystem for the collection, normalization, storage and access to all metadata required for the search, interpretation, and resolution of legislation applicable to the Servicing industry (“The Metadata Repository”—FIG. 2).
5. The system includes applications to provide Internet access to the legislative and interpretive data stores described above (FIGS. 1 & 2).
6. The system includes a storage subsystem for the collection, normalization, storage and access to business rules supporting the execution of automated processes representing the proprietary interpretation and resolution of legislation applicable to the Servicing industry, along with customized applications for performing the analysis, documentation, cataloging and implementation to produce such business rules (“The Rules Repository”—FIG. 3).
7. The system includes a business rule based application for the execution of interpreted compliance instructions related to a particular loan or loan portfolio scenario. The output of such execution will be a set of instructions that can be read and interpreted by a computer using standardized protocols (web services, FTP, etc.) (“The Resolution Engine”—FIG. 3).
8. The system includes a storage subsystem for the collection, normalization, storage and access to business contracts supporting the execution of automated processes representing production services performed on behalf of clients and associated system interfaces with third party vendors and/or internally developed production solutions (where “production” refers to the operational processing of artifacts such as letters, images, etc.) (“The Service Manager”—FIG. 4).
9. The architecture, systems, subsystems and databases described will therefore provide a comprehensive solution to the Servicing industry: access to a single source repository of legislation; natural language interpretations of compliance requirements for such legislation; natural language resolutions of compliance requirements for specific loan scenarios for such legislation; rule-based automated resolutions of compliance requirements for specific loan scenarios for such legislation; related production services as dictated by the aforementioned rule-based resolutions.

### DESCRIPTION OF THE INVENTION

1. Typically the burden of research, interpretation and implementation of Compliance legislation is placed on individual Servicing companies, who are often ill-equipped or under resourced for the volume and complexity of the legislation. New legislation is implemented specifically within core servicing systems, without the benefit of a broader perspective of the interactions with existing legislation. Because new legislation requires changes to the existing code base of the actual Servicing systems, traditional approaches introduce cost inefficiencies and risk. With this traditional “hard coded” approach, there is usually no way to document, review and audit implementations in a holistic manner.
2. As a result of the above constraints it is challenging, and sometimes impossible, to meet “time to market” demands of new legislation. It is difficult and costly to test even small changes, as often the entire Servicing application environment must be run to generate the output of the change. New nuances in legislation such as newly required metadata, different calculation methods, or new evaluation criteria can result in wholesale changes to existing programs and databases. Traditional programming methodologies cannot leverage the value-add potential of newer technologies such as rule-based processing (that are perfectly suited to this problem set).
3. In summary, Servicer-based, traditional, compliance implementations cannot take advantage of economies of scale in research, interpretation, legal costs, implementation (e.g. IT development) and production (e.g. letters, mailing and imaging). Smaller companies, such as Interim Servicers, often cannot afford the infrastructure to analyze, process, and produce the required Letters and other artifacts required to stay in compliance. A utility, rule-driven, service-based approach to this business problem is needed.
   This Invention has the following characteristics that resolve the disadvantages of existing approaches:
4. A computer-based system, technology architecture design, business process model, method, computer readable medium comprising software, and associated set of business services, for automatically determining business resolutions to municipal, state, and federal compliance rules, guidelines and legislation relating specifically to Servicing.
5. Generic resolutions and normalized legislative information are provided in human readable form via the internet by proprietary web search and querying applications.
6. Specific resolutions for a loan or loan portfolio are provided in computer readable form via system interfaces.
7. Resolutions are determined based on the physical location of the property or person and the laws applicable to the property or person location, and such additional criteria as may be required to determine accurate resolution in compliance with the identified legislation.
8. Data Management is provided for current and relevant legislation; associated Mortgage and Credit business terms, concepts and references (“metadata”); proprietary interpretations of legislation as it is to be implemented for the Servicing business; and executable business rules that determine the required and appropriate actions to comply with the relevant legislation.
9. A tiered technology, data, and service architecture (“the architecture”) provides persistent knowledge bases for the different layers of data previously described, as well as proprietary computer-based applications for the management and processing of such data. These tiers are: “Tier 1: The Law Library” (FIG. 1); “Tier 2: The Resolution Advisor” (FIG. 2); “Tier 3: The Resolution Engine” (FIG. 3); and “Tier 4: The Service Manager” (FIG. 4). Tiers 1 & 2 will store and process legislative data, compliance interpretations, and metadata. Tiers 3 & 4 will store and process mappings of business rules corresponding to particular loan scenario(s) being serviced. These tiers are aligned to the proposed services provided to customers, but are interdependent components of the architecture.
10. A rule engine executes the programming code and maps the programming concepts to functions that are associated with a particular loan based on the location of the property or person, and the status and characteristics of the loan. Web based applications provide graphical interfaces with customers; system interfaces are provided via standard protocols (web services, FTP, APIs, etc.).
   Editorial Note: Mortgage and Credit Servicing is an entirely distinct and different business problem and corporate market segment than Mortgage and Credit Origination, with a significantly more complex compliance environment,

### DESCRIPTION OF THE DRAWINGS

Figure One—Law Library

A: Data Capture: Relevant Mortgage Servicing Legislation

A-1: Federal, State and Municipal legislative bodies provide relevant legislation either electronically or hardcopy.

A-2: Data consolidation vendors supply relevant legislation either electronically or hardcopy.

B: Data Entry:

B-1: Data Entry personnel enter legislation in a normalized and cataloged form to the Law Library Database.

B-2: Leverages specialized software (ETL, natural language processor, etc.) to parse and load data automatically.

C: The normalized and scrubbed data is fed to the Law Library Database along with catalog information and metadata for search.

D: The Law Library Database stores the normalized and cataloged legislation for presentation to Tier 1 users and for use by Tier Two applications.

E: A Compliance Officer confirms the accuracy of the relevant legislation in the Law Library Database and adds additional metadata.

F: How the Law Library Database is used:

F-1: Tier 1 Clients—Loan Servicers, Legislators, Litigators and other Tier 1 Clients may research consolidated and cataloged legislation contained in the Law Library Database over the Internet, via a proprietary web based application.

F-2: Tier 2 Applications—The Law Library Database is leveraged by Tier 2 applications and business processes in the formulation of appropriate compliance resolutions, the population of The Resolution Advisor Database, and the provisioning of Tier 2 Services (see FIG. 2).

G-: Tier 1 Clients—Loan Servicers, Legislators, Litigators and other Tier 1 Clients

Figure Two—Resolution Advisor

A: The Law Library Database stores normalized and scrubbed legislative data, along with catalog information and metadata for search (see FIG. 1).

B: The Mapping & Interpretation Applications facilitates a Compliance officer in creating proprietary compliance resolutions based on the relevant legislation. New legislation is reviewed from the Law Library Database and resolutions are formulated and written to the Resolution Advisor Database and enriched with metadata mapping from the Mortgage Servicing Metadata Database.

C: A compliance officer determines the appropriate resolutions to the relevant legislation and creates interpreted outcomes for loan scenarios using the Mapping & Interpretation Applications.

D: The Resolution Advisor Database stores interpreted outcomes for loan scenarios.

E: The Mortgage Servicing Metadata Database provides contextual information and metadata for the search and execution of interpreted loan outcomes. For Tier 2 functionality, it enables rich web based search of the Resolution Advisor Database.

F: How the Resolution Advisor is used:

F-1: Tier 2 Clients—Clients can enter loan scenarios over the Internet using the Resolution Advisor proprietary web application. Based on the scenario criteria, recommended activities (resolutions) are returned based on the interpreted loan outcomes in the Resolution Advisor Database.

F-2: Tier 3 & 4 Applications—The Resolution Advisor Database is leveraged by Tier 3 & 4 applications and business processes in the development of Business Rules (see FIGS. 3 & 4).

G: Tier 2 Clients—Enter loan scenarios over the Internet using the Resolution Advisor proprietary web application

Figure Three—Resolution Engine

A: The Resolution Advisor Database stores interpreted outcomes for loan scenarios (see FIG. 2).

B: Proprietary Rules Development Applications facilitate the creation and management of Business Rules, based on the resolutions in the Resolution Advisor Database.

C: A Rules Analyst creates Business Rules using the Rules Development Applications.

D: Business Rules are stored and cataloged in the Resolution Rules Repository.

E: The Resolution Engine executes Business Rules stored in the Resolution Rules Repository

E-1: Attributes of the client's Loan Portfolio trigger execution of the appropriate Business Rules

E-2: The Resolution Engine generates a set of instructions based on the executed Business Rules

F: System Interface allows transmission of data between Tier 3 client systems and Resolution Engine

F-1: Clients transmit their loan portfolios via the appropriate system interface

F-2: Resolution instructions based on the submitted loan portfolio are transmitted back to the client systems

G: Tier Three Clients—Transmit their loan portfolios via the appropriate system interface

Figure Four—Service Manager

A, B, C, D—See descriptions for FIG. 3

E: The Resolution Engine executes Business Rules stored in the Resolution Rules Repository

E-1: Attributes of the client's Loan Portfolio trigger execution of the appropriate Business Rules

E-2: Execution results are returned to the System Interface for delivery to the client

F: System Interface allows transmission of data between Tier 4 client systems and Resolution Engine

F-1: Clients transmit their loan portfolios via the appropriate system interface

F-2: Execution results based on the submitted loan portfolio are transmitted back to the client systems

G: Tier four Clients—Transmit their loan portfolios via the appropriate system interface

H: The Service Manager Application prepares instructions for production activities (Letters Templates, etc.) based on the resolution instructions generated by the Resolution Engine, and transmits them to the appropriate service providers (print and imaging vendors, etc.).

H-1: Resolution instructions are sent from Service Manger, to the Service Providers

H-2: Execution results are sent from the Service Provider to the Service Manager and from the Service Manager to the tier four clients

1. The Invention provides a “one stop” solution to mitigate legislation affecting the Servicing industry that is enacted at various governmental levels (including Federal, State and Municipal legislative bodies). This removes the burden of research, interpretation and implementation from individual Servicing companies, who are often ill-equipped or under resourced for the volume and complexity of the legislation. (Independent claim No. 1)

2. The Invention provides an industry standard utility solution that treats Servicing Compliance as a discrete problem set, replacing the customized solutions that are currently fragmented across the processing environments of different Servicing companies. (FIGS. 1, 2, 3, 4), dependant on claim: (1).

3. The Invention provides a generic, utility solution for research, interpretation and implementation of legislative requirements that is independent of proprietary servicing platforms and companies. (FIG. 1 and FIG. 2), dependant on claim: (1).

4. The Invention enables the resolution of new legislation within the context of existing related resolutions, due to the centralized processing and data architecture, giving a holistic view of all legislation, compliance interpretations, and rules related to a specific loan scenario. (FIGS. 1, 2, 3), dependant on claim: (1).

5. The Invention enables the centralized and controlled provisioning of value-add production services such as letters generation, printing, imaging and mailing. (FIG. 4), dependant on claim: (1).

6. The Invention resolves the traditional high cost of managing Servicing compliance within individual Servicing companies that typically requires interpretation, resolution and implementation either manually or by specially developed computer programs. (Independent claim No. 2).

7. The Invention enables standardized and transparent interpretations of legislation. Today each Servicing company creates its own interpretation of legislation and such interpretations are not readily visible to auditors, legislators, litigators or ratings agencies. (FIG. 2), dependent on claim: (6).

8. The Invention expedites corporate compliance, which is critical given the penalties for non-compliance. New legislation can be implemented quickly and efficiently. The production of instruction sets is agnostic and non-invasive to the code base of existing Servicing systems—minimizing cost, risk and time-to-market. (FIG. 3 and FIG. 4), dependant on claim: (6).

9. The Invention addresses all determining factors required from a Servicing perspective such as status, lifecycle variances and characteristics of the loan (unlike Loan Origination solutions, where compliance with relevant legislation is simply determined by comparing the physical location attached to a specific loan with the relevant Origination legislation). (FIG. 2), dependant on claim: (6).

10. The Invention leverages economies of scale in research, interpretation, legal costs, implementation (e.g. IT development) and production (e.g. letters, mailing and imaging). (FIG. 4), dependent on claim: (6).

11. The Invention provides a packaged solution for smaller companies, such as Interim Servicers, who cannot afford the infrastructure to analyze, process, and produce the required Letters and other artifacts required to stay in compliance. (FIGS. 1, 2, 3, 4), dependant on claim: (6).

12. The Invention provides an alternative technology design to known computer based approaches to resolving Servicing Compliance requirements that are implemented using traditional project and programming methodologies. Typically, new compliance logic is designed in the context of existing system processes and the resolution is embedded in the code of the Servicing system (“hard coded”). (FIG. 3). (Independent claim No. 3).

13. The Invention provides currently unavailable web search and analysis capabilities for legislation related to the Servicing industry. Although several legislative data providers exist today (Lexus Nexus, etc.) there is no single source repository for Servicing legislation. (FIG. 1), dependant on claim: (12).

14. The Invention provides a mechanism to document, review and audit implementations in a holistic manner. Transparency, monitoring, auditing, and maintenance of resolutions can be problematic due to the “hard coded” nature of typical implementations. (FIGS. 1, 2, 3, 4), dependant on claim: (12).

15. The Invention creates an efficient, transparent, homogenous and encapsulated environment for testing. This promotes accuracy and consistency of implementation. (FIGS. 1, 2, 3, 4), dependant on claim: (12).

16. The Invention facilitates the efficient implementation of new nuances in legislation such as new required metadata, different calculation methods, or new evaluation criteria. For example, centralized and normalized data, business rules and metadata management allow for changes to be made holistically for all associated resolutions, rather than having to update multiple fragments of code. (FIG. 2 and FIG. 3), dependant on claim: (12).

17. The Invention leverages the value-add potential of newer technologies such as rule-based processing and Service Oriented Architecture (SOA). (FIG. 3 and FIG. 4), dependant on claim: (12).
